(19) United States
(12) Patent Application Publication
(10) Pub. No.: US 2010/0092932 A1
(43) Pub. Date: Apr. 15, 2010

(54) AWARDS MANAGEMENT METHOD

(76) Inventor: George A. Castineiras, Farmington, CT (US)

Correspondence Address: MICHAUD-Kinney Group LLP, 306 INDUSTRIAL PARK ROAD, SUITE 206, MIDDLETOWN, CT, 06457, US

(21) Appl. No.: 12/578,140

(22) Filed: Oct. 13, 2009

Related U.S. Application Data
(60) Provisional application No. 61/105,158, filed on Oct. 14, 2008.

(51) Int. Cl. G09B 17/00

(52) U.S. Cl. 434/178

(57) ABSTRACT

In a method for promoting literacy, a website is hosted wherein a literacy award competition is facilitated. Criteria are provided to applicants for the literacy award, the criteria being accessible via the website. Access is provided to a plurality of sponsors via the website. One or more requests are received from at least one of the applicants for access to one or more of the sponsors, the request being in a form specified by the criteria. The requests are evaluated and the applicant with whom the request is associated is credited with an acknowledgment, displayable on the website and indicating that the applicant has met the criteria for accessing information or indicia associated with the sponsor. The acknowledgments associated with the applicant are stored and an award is generated when a predetermined number of the acknowledgments from different sponsors are associated with the applicant.

### CROSS REFERENCE TO RELATED APPLICATION

This application claims the benefit of U.S. Provisional Patent Application Ser. No. 61/105,158, filed Oct. 14, 2008, which is incorporated herein by reference, in its entirety.

### FIELD OF THE INVENTION

The present invention is generally directed to an awards management method and is more specifically directed to a method for promoting literacy through creative arts displayed on postage stamps.

### BACKGROUND OF THE INVENTION

It is well known that education is the foundation for academic advancement and that engaging in creative arts can be used to promote such advancement, especially in children. Reading and writing, particularly writing to relate a creative event such as describing a piece of artwork, helps to develop the process of thinking and promotes articulation that is beneficial to clearly express concepts, convey emotions as well as information, build cognitive skills, and allow for effective negotiation and other interaction in social contexts.

While text messaging, instant messaging, and other abbreviated methods of communication can be used to effectively communicate some types of information, they fall short of developing thinking processes and building the skills generally useful for relating concepts and ideas either back to other concepts and ideas or to real-world situations. For example, even a rudimentary analysis of the concepts of “freedom,” “truth,” “beauty,” and “wisdom” discussed in the writings of Plato would be difficult if not impossible to convey in any understandable way to a reader using text messaging. These concepts are creative in nature and typically require a fair amount of skill to express. Just as television viewing (even with regard to the most complex subjects and well-produced presentations) cannot replace reading for comprehension, abbreviated forms of the written word cannot facilitate the adequate transfer of concepts and ideas because they generally lack any form of substantive thought processing.

Additionally, the emotional and psychological benefits of composing, sending, and receiving well thought-out written communications are unmatched relative to other communication methods. In particular, handwritten letters expressing gratitude or well wishes will likely always be found to be preferable to standard greeting cards having preprinted artwork and wording that are typically just signed, sent, read one time, and thrown away.

### SUMMARY OF THE INVENTION

The present invention contemplates promoting writing and the creative arts in combination by recognizing and rewarding authors and artists for their creativity in an effort to help improve literacy levels.

In one aspect, the present invention resides in a method of promoting literacy by providing incentives. In this method, a set of rules is provided to a participant. The set of rules is received by the participant using a computer-based platform, which provides for an efficient method of administering the method and allows various aspects thereof to be tracked. If the participant wishes to proceed according to the rules, an application is made by the participant and processed by an administrator. In processing the application, a category into which the application can be placed is identified, criteria for evaluating the application are specified, and the specified criteria are implemented. Based on the evaluation, an award may be issued to the participant.

In another aspect, the present invention resides in a method of managing an award process. In this method, a set of rules for a contest is determined, and applications are received from potential participants. The received applications include the collection of at least one article (e.g., a state-issued stamp or the like) by each participant's use of a web-based computer interface. The applications are then categorized based on specified criteria. An administrator then implements the specified criteria and substantively evaluates the received applications based on the specified criteria. Awards may then be issued based on the substantive evaluations of the received applications. The method may be implemented using a computer-based system.

In another aspect, the present invention resides in a method of managing a computer-based award process to promote literacy. In such a method, a set of rules applicable to the participants in determined. The collection of one or more articles by each participant using a web-based interface is then facilitated. Once applications are received from the participants, the applications are processed to ensure that they are in compliance with the rules. The received applications are then categorized into predefined categories and evaluated based on specified criteria. An award may then be provided to one or more participants in each category based on the evaluated specified criteria.

### DESCRIPTION OF THE DRAWINGS

FIG. 1 is a flowchart illustrating a method of the present invention involving promoting literacy.

FIG. 2 is a schematic diagram of a computer system platform on which the method of the present invention is based.

FIG. 3 is a flowchart illustrating a prerequisite step of a method of the present invention.

FIG. 4 is a flow chart illustrating application rules of the method.

FIG. 5 is a flow chart illustrating awards processing steps of the method.

FIG. 6 is a spreadsheet of a sponsorship structure.

FIG. 7 is a spreadsheet of a revenue structure.

FIG. 8 is a spreadsheet of an expense structure.

FIG. 9 is a flow chart of a national literacy award process.

FIG. 10 is a flow chart of a sponsor overview corresponding to FIG. 8.

### DETAILED DESCRIPTION

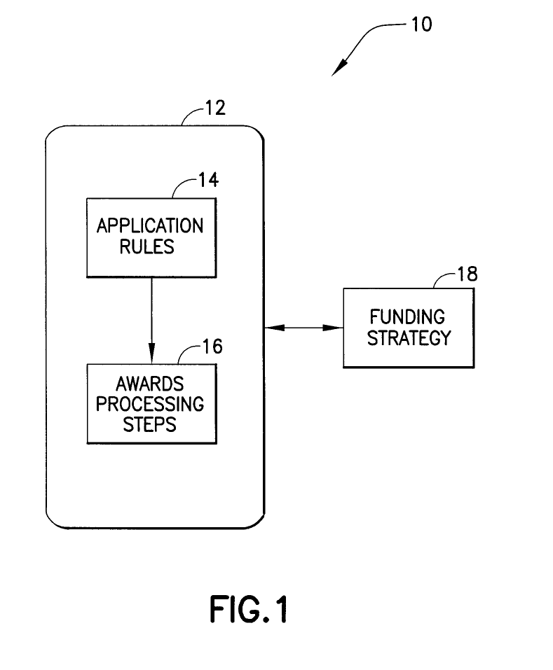

As shown in the flow chart of FIG. 1, an awards management method directed to promoting literacy in school-aged children, in accordance with the present invention and hereinafter referred to as “the literacy award process,” is generally designated by the reference number 10. The literacy award process 10 includes a sub-process 12 having application rules 14 and award processing steps 16. The literacy award process 10 is supported by a funding strategy 18. Although the awards management method described herein is referred to as “the literary award process 10,” it should be understood by those of skill in the art that the elements of the process described herein can be applied to other incentive and award processes and used as or in conjunction with fundraising and promotional events.

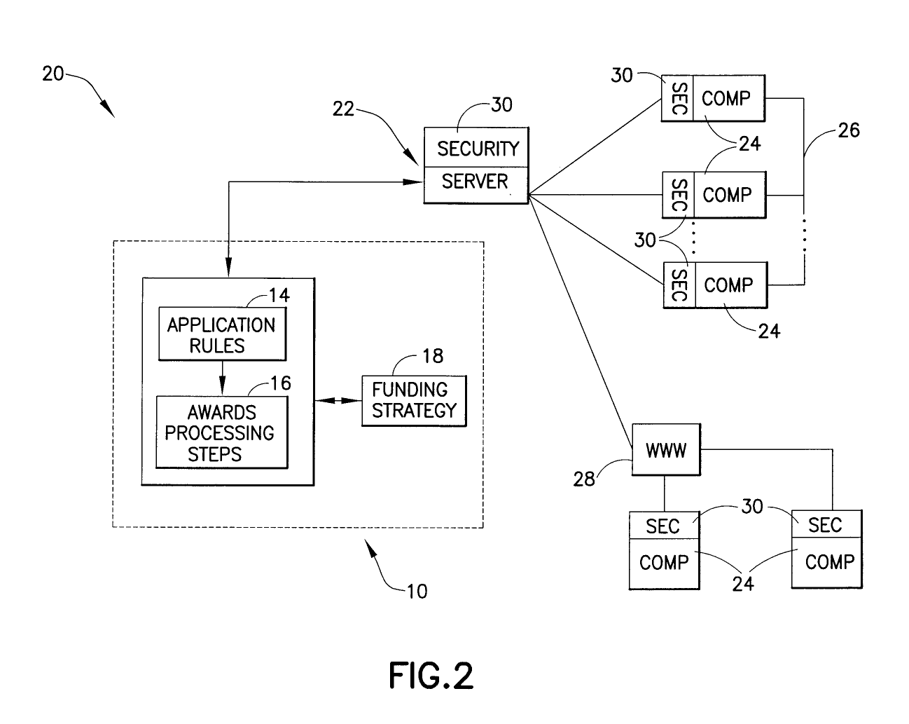

Referring now to FIG. 2, the literary award process 10 may be based on a suitable platform from which the sub-process 12 and the funding strategy 18 can be executed or otherwise observed, manipulated, and controlled. One exemplary suitable platform may be a computer system 20 as is shown. The computer system 20 includes a server 22 and one or more computer terminals 24 through which the server can be accessed. When multiple computer terminals 24 are employed, they may be linked to form a local area network (LAN) 26. In the alternative, or in addition to the use of a LAN, one or more computer terminals 24 may be linked to the literary award process 10 via a web-based interface 28 such as the Internet or World Wide Web (www). The present invention is not limited to the literary award process 10 being based on a computer system, however, as the literary award process may be carried out using a paper-based system (e.g., without being linked to computer terminals through a server).

Embodiments of the literary award process 10 in which a computer system 20 is used may also employ one or more security features 30. The security feature 30 facilitates the proper and desired operation of the literary award process 10 by inhibiting access thereto by unauthorized individuals. In doing so, the integrity of the literary award process 10 can be ensured or at least promoted to a degree that minimizes the opportunity to gain access to information that may prejudice the interests of a person participating in or an entity administering the literary award process.

The security feature 30 may be a password protection aspect that can be used to limit user access to selected persons. Such a password protection aspect can be applicable to each individual computer terminal 24 accessible, or it may be applied through and/or used in conjunction with the server 22. In a configuration in which the literary award process 10 is accessed through the web-based interface 28, the security feature 30 can be employed at any suitable juncture (e.g., computer terminal 24, server 22, or the like) in a path of access between a user and the process 10.

In embodiments of the literary award process 10 based on a computer platform, the security feature 30 is not limited to password protection. In particular, the security feature 30 may employ any suitable means of limiting access to the literary award process 10 including, but not limited to, providing physical devices such as locks and keys, and the like.

While the awards management process is described as being directed to promoting literacy, the present invention is not limited in this regard as the method can also be applied to promoting other purposes including, but not limited to, health awareness, environmental preservation, clean energy, and global economics, without departing from the broader aspects of the present invention. Although the literacy awards process 10 is described and shown to be directed to promoting literacy of school-aged children, the literacy awards process can also be applied to promote learning in disabled people, learning an additional language, and adult education.

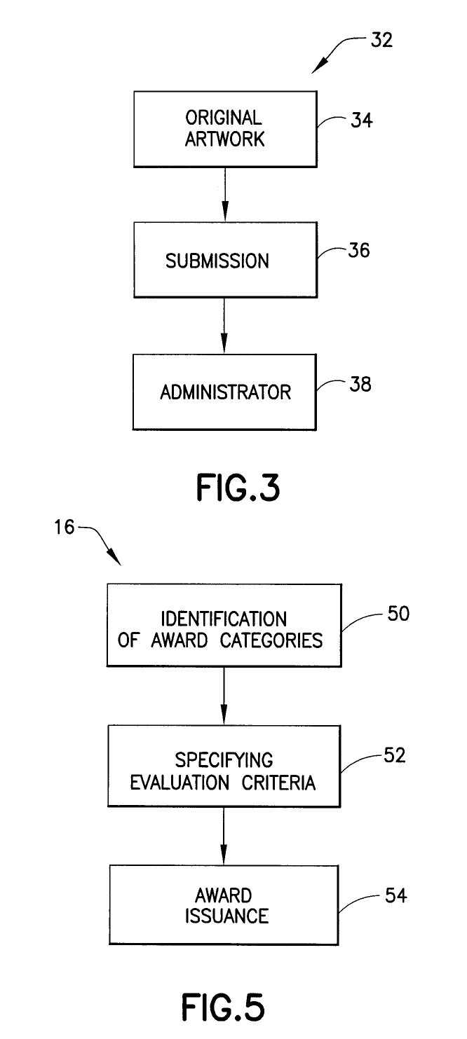

Referring now to FIG. 3, the application rules 14 include a prerequisite step 32 to be completed in order to participate in the literacy award process 10. For example, the prerequisite step 32 can include a requirement that applicants have participated in a fundraising activity wherein the participants have generated original artwork for use on custom postage or on stationery items. Such fundraising activities include, but are not limited, to those described in co-pending U.S. patent application Ser. No. 11/168,651, entitled “Method for Generating Custom Postage Stamps,” filed Jun. 27, 2005, and U.S. patent application Ser. No. 11/396,895, entitled “Method for Generating Custom Postage as Part of a Fundraising Event,” filed Apr. 3, 2006, the subject matter of which is incorporated by reference herein in its entirety.

The requirement of the prerequisite step 32 can be to meet a prerequisite, which may be the completion of a form, certificate, chit, written statement, essay, or any other article 34 that can be presented to validate an assertion that the applicant has participated as necessary and that the prerequisite has been met. In instances in which the requirement is that the applicant has participated in an activity in which an article 34 (e.g., original artwork) was generated, validation of the assertion could be the submission of the actual article 34 (or a suitable copy thereof) in a submission step 36 to a relevant administrator 38 of the literary award process 10. When the article 34 is submitted in the submission step 36 and accepted by the administrator 38, the prerequisite 32 can be deemed to have been met.

The above-described prerequisite requirement can be implemented and completed electronically by employing one or more computers, the Internet and at least one website. For example, the prerequisite could be the submission of an essay. This essay can be submitted by uploading the essay to a website via the Internet. Alternately, a participant may access the website and type, speak, or otherwise submit his/her essay directly into the website.

Where the prerequisite involves the submission of original artwork, the artwork can be scanned and uploaded to the website where it would be stored in a database associated therewith, until such time as the digital image of the artwork can be reviewed.

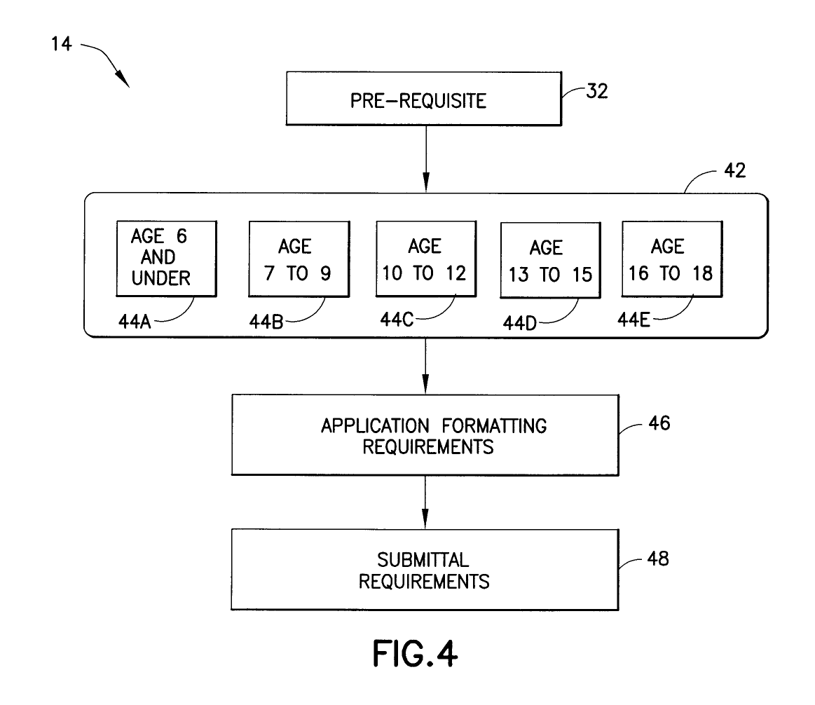

Referring now to FIG. 4, in any embodiment of the literary award process 10 irrespective of whether the computer system 20 is used, the application rules 14 may also include specifying various criteria in addition to the article 34 (or copy thereof), such as age-based application criteria 42 including an essay topic and the required number of words in an essay to be submitted with an application. For example, FIG. 4 illustrates five age groups 44A-E, namely, age six and under, ages seven to nine, ages ten to twelve, ages thirteen to fifteen, and ages sixteen to eighteen. The essay topics and number of words required in the essay are illustrated as follows: 1) ages six and under, 20 to 40 words regarding “What is your favorite thing?”; 2) ages seven to nine, 100 to 150 words on the topic of “Who do you admire the most and why?”; 3) ages ten to twelve, 200 to 300 words on the topic of “Which innovation to date are you most inspired by and why?”; 4) ages thirteen to fifteen, 300 to 400 words on the topic of “Where do you see yourself 30 years from now and why?”; and 5) ages sixteen to eighteen, 400 to 500 words on the topic of “If you were president, what is the first thing you would change and why?”

Where a computer system 20, the Internet and at least one website are employed, the website could have designated areas for the prerequisite submissions, dedicated to each age group. The submissions may be generated in these designated areas or they may be uploaded into these areas. While the designated areas on the website have been described as pertaining to different age groups, the present invention is not limited in this regard as the different areas can be segregated in accordance with other criteria. For example, the areas could be divided according to geographic area, by subject matter, by sex, or the like.

While the step of specifying age-based application criteria 42 is shown and described as specifying five age groups of age six and under, ages seven to nine, ages ten to twelve, ages thirteen to fifteen and ages sixteen to eighteen, the present invention is not limited in this regard as any number of age groups, any range of ages and groups based on grade level, academic achievement and/or other demographic criteria can also be employed. In addition, while specific essay topics have been described for each age group, the present method is not limited in this regard as the essay topics can be all the same or other topics can be employed without departing from the broader aspects of the present invention.

As illustrated in FIG. 4, the application rules 14 include specifying application formatting requirements 46. For example, where a school is involved, the formatting requirements may include providing information about the student, the student's teacher and school, essay format, and the relative positioning thereof. In particular, the formatting requirements 46 can be provided in a template which includes fields for: 1) the student's name, age, grade; 2) the student's parent's contact information including their name, address, and e-mail address; 3) the student's school information including school name and address; 4) the name of the student's teacher; 5) a section for writing the essay; 6) a section and/or instructions for submitting the article 34 (e.g., a postage stamp displaying the student's original artwork thereon) consistent with the prerequisite 32; and 7) an address to which the application must be submitted. The method also includes instructions for submitting the application for the literacy award (such as submittal requirements 48); for example, the essay can be required to be handwritten.

The above-described template can be incorporated into a website accessible via the Internet, such that the template can be filled out online.

Referring to FIG. 5, award processing steps 16 include identification of award categories 50, specifying and implementing evaluation criteria 52 and issuance of an award 54. Identification of award categories 50 can include specifying the number and type of awards classified into predefined categories. For example, for each age group 44A-E, three award levels including the following can be employed: 1) one first place award of $500 and an award plaque; 2) four runner up awards of $50 and award plaques; and 3) five honorable mentions awards and award plaques. While three levels of awards are described, the present invention is not limited in this regard as any number of award levels and monetary amounts may be employed without departing from the broader aspects of the present invention.

The specification and implementation of evaluation criteria 52 includes reviewing and comparing the applications for compliance with the formatting requirements 46 and submittal requirements 48 and a substantive evaluation of the essays including consideration of legibility (if handwritten), content, and originality.

When the submissions are made to the website, the evaluations could be done online using judges from many different areas. For example, if the participants were drawn from schools across the country, judges could be selected from school staff from different schools in different locales.

The issuance of awards step 54 includes identification of the date by which the evaluation criteria will be implemented and the date and manner of announcing and presenting the awards. For example, the award announcements could be posted on a website e-mailed to recipients, or recipients could be notified via text message.

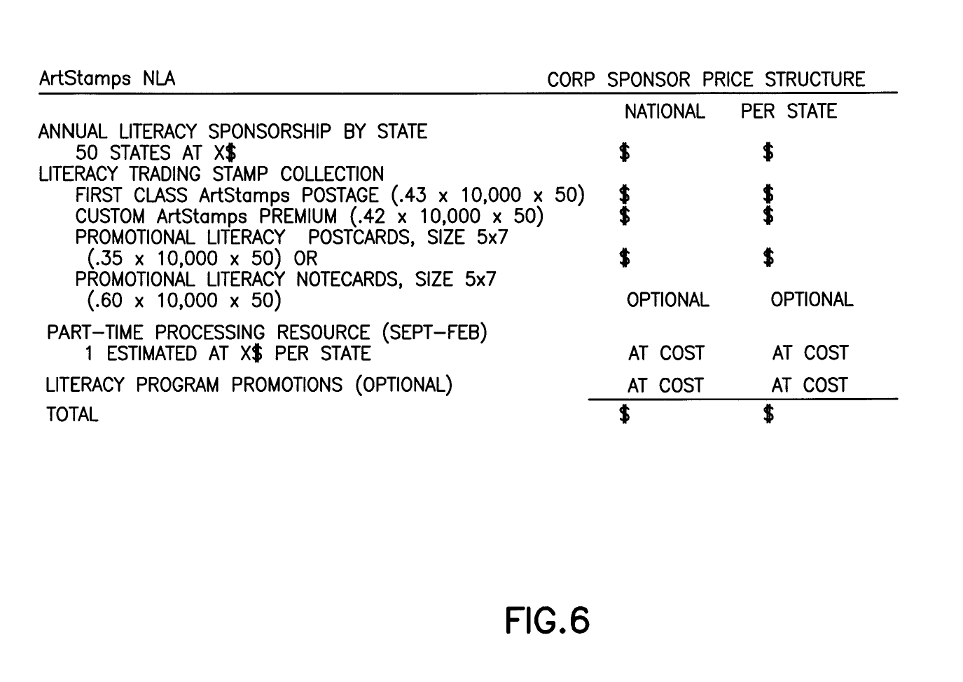

The funding strategy 18, as shown in FIGS. 1 and 2 includes sponsorship, revenue, and expense structures. These sponsorship, revenue, and expense structures are illustrated in FIGS. 6-8, respectively. This funding strategy 18 is based upon the use of a promotion that employs a contest in which participants submit an article (article 34), for example, original artwork that can be printed onto custom postage to be sold through the U.S. Postal System via a website, or by participants. In FIG. 6, a sponsor price structure for the funding strategy 18 is illustrated, this price structure being one example of a price structure in which a corporate entity sponsors the promotion by agreeing to absorb the costs associated with producing various materials used in the promotion.

Corporate sponsors could also simply donate funds. In exchange for such donations, the corporate sponsors could be allowed to advertise on the above-described website. Such sponsor could also be recognized on other materials and awards or, as will be explained below, such sponsors could also participate in the application process.

The present invention is not limited to the application of the contest to stamps, postcards, and notecards, however, as other articles can be produced. In the sponsor price structure of FIG. 6, ten thousand units each of postage, custom artwork for custom postage, postcards, and notecards are produced. The custom artwork for the custom postage, as well as the designs of the postcards and notecards, are derived from the article 34. Records relating to the sponsor price structure may be maintained on a storage medium and made accessible through the computer system 20.

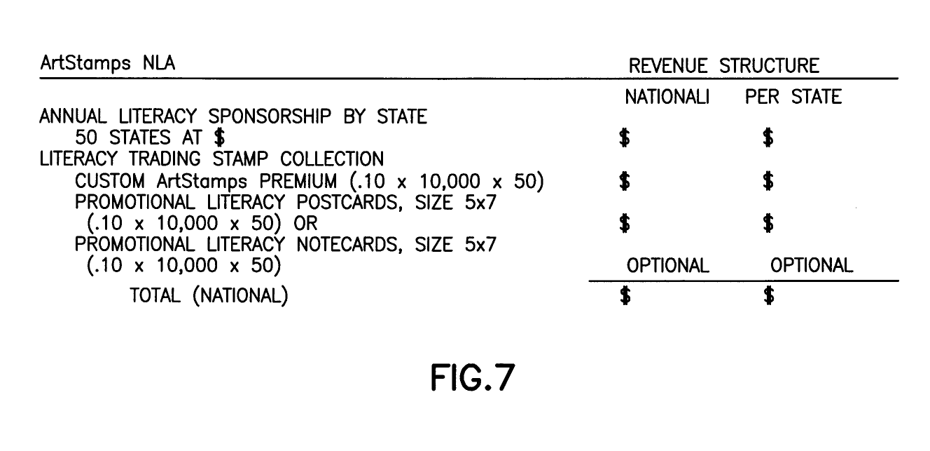

In FIG. 7, the revenue structure of the funding strategy 18 for ten thousand units each of custom artwork for the postage, postcards, and notecards is illustrated. As with the sponsor price structure, records relating to the revenue structure may be maintained on a storage medium and made accessible through the computer system 20.

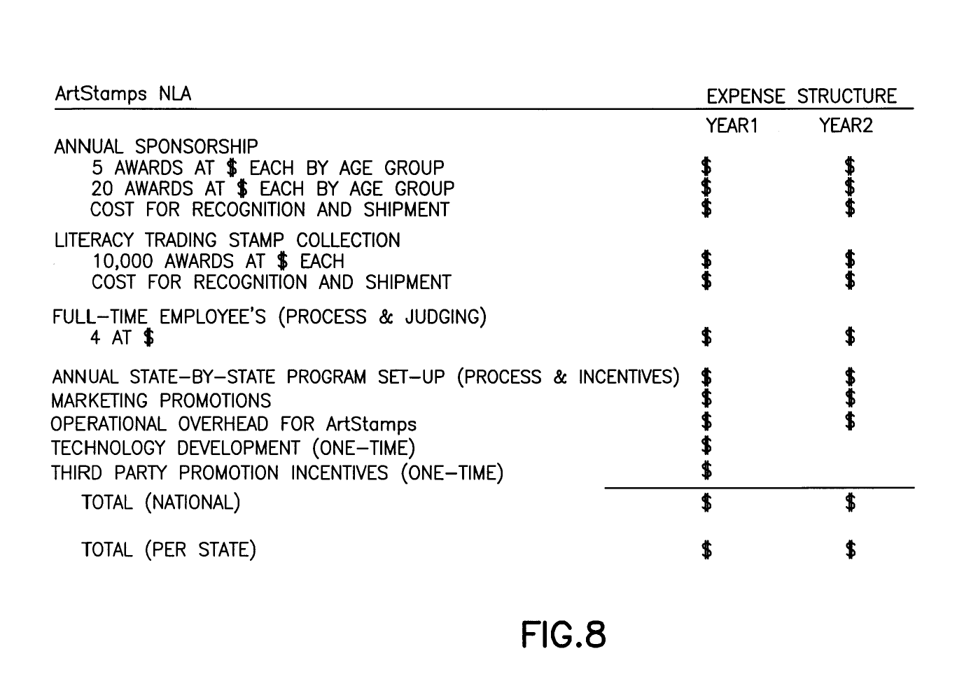

In FIG. 8, the expense structure of the funding strategy 18 is shown. Although the expense structure is shown for two years, the expense structure can be tracked for any number of years. The present invention is not limited to the expense structure being tracked in yearly increments, however, as the expenses can be listed on a quarterly, monthly, weekly, daily, or other basis. The expenses can include data relating to overhead costs (e.g., processes and judging, marketing, and the like). When the expense structure is part of a process such as the literary award process 10, expenses listed can also include the costs for awards and the like and be tracked by age group. As with the sponsor structure and the revenue structure of the funding strategy 18, the expense structure can be maintained on a storage medium and made accessible through the computer system 20. The expense structure (and also the sponsor and revenue structures) may be maintained on an electronic spreadsheet.

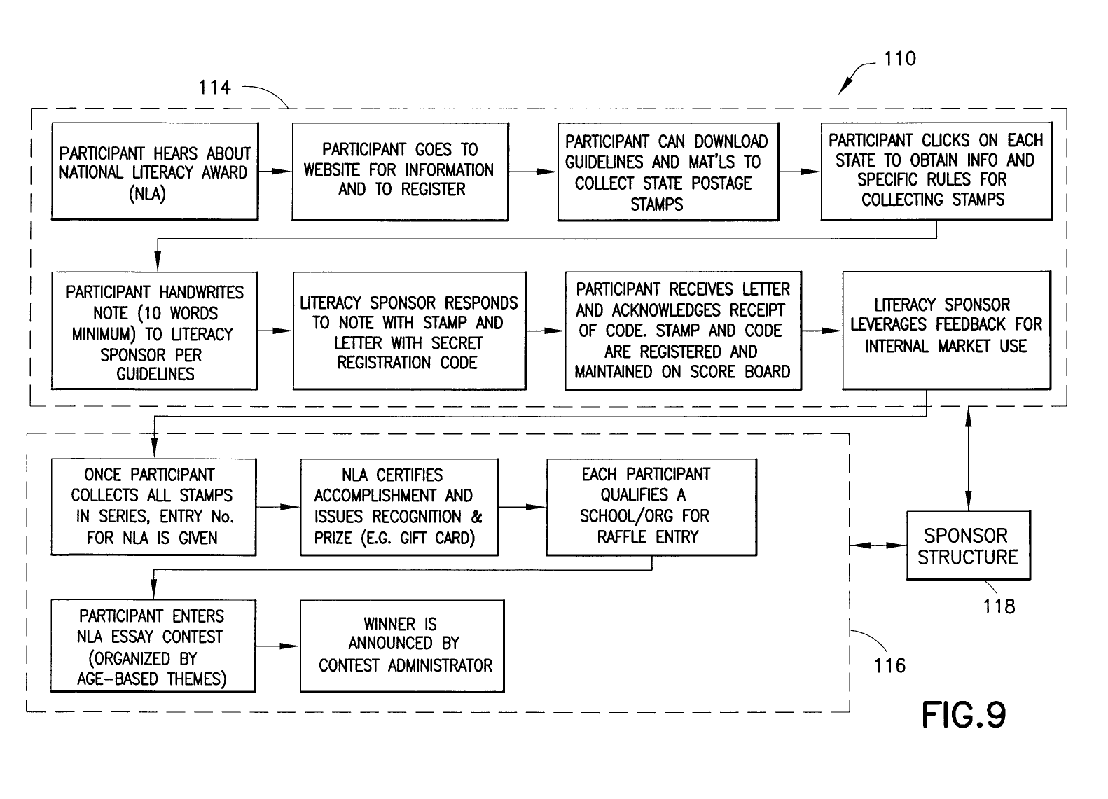

The method for promoting literacy shown in FIG. 9 is similar to that illustrated in FIG. 1. Therefore, like elements will be given like numbers preceded by the numeral 1. Referring to FIG. 9, a national literacy award process 110 is shown wherein each of the fifty States in the United States has at least one sponsor and a custom postage stamp associated with that State (i.e., State postage stamp). The national literacy awards process 110 includes application rules 114 and awards processing 116 steps. As described in detail below and shown in FIG. 9, the national literacy process 110 also includes a sponsor structure 118.

As part of the application rules step 114, the applicant is provided information about and registration for the national literacy award process online via the Internet. The applicant writes a request to each sponsor to obtain the custom postage for that State in an effort to collect all fifty State postage stamps.

In one embodiment, the custom postage corresponding to each State can be viewed on a website and the applicant can write his/her requests either while on the website in a designated area or can upload the requests. The designated area can include one or more different manners by which the requests can be sent. For example, one or more drop-down menus can be provided that allow an applicant to send his/her request to the appropriate entity. In addition, a list of e-mail addresses could be provided to the applicant. Still further, the website could have a dedicated web page for each State's custom postage that can be accessed by the applicant. The website could also be set up so that an applicant can register for an e-mail address associated with that website so that communications by the applicant with sponsoring entities can be made via this e-mail address.

Moreover, each applicant can be given an area on the website where the applicant can view the custom postage he/she has collected. If the applicant's request complies with predetermined requirements, physical custom postage could be transmitted to the applicant or an electronic image of the custom postage could be stored on the website. The national literacy awards process 110 is not limited to the collection of postage stamps, however, as other articles, either tangible or intangible (such as codes, data, or similar information), can be collected from sponsors.

As part of the awards process 116, after the applicant obtains all fifty pieces of State custom postage, the applicant can be sent one or more of the following: a certificate of achievement, an initial monetary award, or an entry number for an essay portion of the national literacy award process.

The certificate of achievement, if awarded, can be awarded to the applicant in electronic form either by accessing the website or via e-mail. Moreover, the initial monetary award may be in the form of a credit issued to the applicant towards the purchase of merchandise offered on the website and/or merchandise offered by one or more sponsors.

Applicants who submit the tracking codes provided from each State sponsor and an essay meeting age group specific and/or other specified criteria, or who can otherwise demonstrate that they have collected (via the electronic images or other indicia shown on the website and indicating that the images and/or indicia are associated with the applicant), are eligible for a larger monetary award and additional recognition of achievement. The applicants' submissions and essays will be independently judged and awards administered based on predetermined criteria. The judging of applicants' essays and/or submissions can be done electronically by judges located in different geographic areas. The judges can access the essays and/or submissions via the website with their decisions and/or comments being accessible via the website.

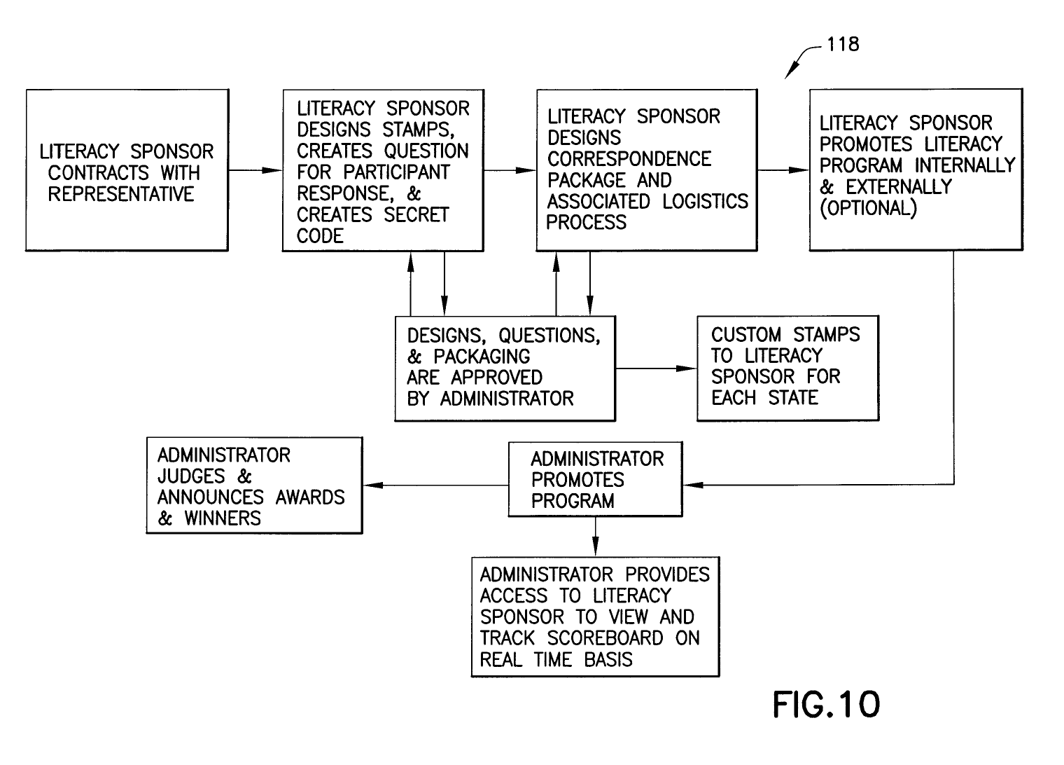

Referring to FIG. 10, an overview of a sponsor structure 118 for the national literacy award process includes identifying sponsors for each of the fifty States. In coordination with a national literacy award coordinator, the sponsor creates custom postage for that State and in one embodiment specifies questions, which the applicant must answer to obtain that State's custom postage. The sponsor and/or the coordinator promote the national literacy award program. Electronic records of each State's custom postage requests, applications, essays, awards and other correspondence are maintained by the coordinator and/or the respective State sponsors. Alternately, the award coordinator and the sponsors can communicate electronically via the website. Moreover, the States' custom postage can be viewed as an image on the website with orders for the custom postage being submitted via the website. In addition, the above-described electronic records can be stored in one or more databases associated with the website.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above-detailed description, but that the invention will include all embodiments falling within the scope of the appended claims.

What is claimed is:

1. A method for promoting literacy comprising:
hosting a website wherein a literacy award competition is facilitated;
providing criteria to applicants for said literacy award, said criteria being accessible via said website;
providing access to a plurality of sponsors via said website;
receiving one or more requests from at least one of said applicants for access to one or more of said sponsors, said request being in a form specified by said criteria;
causing said requests to be evaluated and crediting said applicant with whom said request is associated with an acknowledgment, displayable on said website, that said applicant has met said criteria for accessing information or indicia associated with said sponsor;
storing said acknowledgments associated with said applicant; and
generating an award when a predetermined number of said acknowledgments from different sponsors are associated with said applicant.

2. A method as defined by claim 1 wherein:
said acknowledgments include images of custom postage displayable on a webpage forming part of said website; each of said images being associated with at least one of said sponsors so that providing access to said sponsor includes providing access to said webpage to view said images of custom postage.

3. A method as defined by claim 2 wherein crediting said applicant with whom said request is associated with an acknowledgment, displayable on said website includes:
generating a display on at least a portion of said website showing said acknowledgements associated with a particular applicant.

4. A method as defined by claim 3 further comprising:
allowing said applicant to participate in a literacy award competition upon said predetermined number of said acknowledgments from different sponsors being associated with said applicant;
receiving a writing from said applicant in a form specified by said criteria, said writing being stored such that it is accessible for display on said website;
causing said writings from a plurality of applicants to be evaluated;
generating an award associated with one or more of said applicants; and
notifying said one or more applicants of said award.

5. A method as defined by claim 2 wherein said images of said custom postage are associated with particular states; and
said criteria includes requiring a predetermined number of said images of custom postage associated with different states to be associated with said applicant.

6. A method as defined by claim 1 wherein said sponsors are companies.

7. A method as defined by claim 1 wherein said sponsors are applicants.

8. A method as defined by claim 5 wherein said sponsors are applicants residing in different states.

9. A method as defined by claim 8 wherein said images are created by said sponsors.
